(19) United States
(12) Patent Application Publication
(10) Pub. No.: US 2016/0034603 A1
(43) Pub. Date: Feb. 4, 2016

(54) DATA PROCESSING SYSTEM

(71) Applicant: EDWARD BRIAN DEPENBROCK, Coral Springs, FL (US)

(72) Inventor: EDWARD BRIAN DEPENBROCK, Coral Springs, FL (US)

(21) Appl. No.: 14/449,883

(22) Filed: Aug. 1, 2014

(51) Int. Cl. G06F 17/30

(52) U.S. Cl. CPC G06F 17/30997; G06F 17/30867; G06Q 50/01

(57) ABSTRACT

A method, computer program product, and computing system for receiving a search request from a user of a dating website that defines one or more search criteria. The search criteria is compared to a plurality of user profiles to generate a result set of user profiles. At least one result set user profile included within the result set of user profiles includes a plurality of mutually-exclusive descriptors. The at least one result set user profile is filtered to remove one or more of the plurality of mutually-exclusive descriptors based, at least in part, upon the search criteria to generate a filtered result set of user profiles.

### TECHNICAL FIELD

This disclosure relates to defining data and, more particularly, to defining data for use within a user profile.

### BACKGROUND

When users join various social websites (e.g., social networking websites, dating websites, merchandising websites), these users may be required to define their various preferences. For social networking websites, these preferences may concern their interest in music and food. For dating websites, these preferences may concern the physical description of the user and their preferences for a mate. For merchandising websites, these preferences may concern shipping options and payment options.

While certain types of information may require definitive choices and may be objectively definable, other types need/may not be. For example, if a person defines their height as 5 foot 9 inches tall, they may not also define their height as 6 foot 1 inch tall. However and with respect to other types of information (especially those types of information that do not concern physical characteristics and concern e.g., personal preferences/choices/interests), the user may wish to vary their preferences/responses depending upon the specific interest/situation/condition.

Summary of Disclosure

In one implementation, a computer-implemented method, executed on a computing system, includes receiving a search request from a user of a dating website that defines one or more search criteria. The search criteria is compared to a plurality of user profiles to generate a result set of user profiles. At least one result set user profile included within the result set of user profiles includes a plurality of mutually-exclusive descriptors. The at least one result set user profile is filtered to remove one or more of the plurality of mutually-exclusive descriptors based, at least in part, upon the search criteria to generate a filtered result set of user profiles.

One or more of the following features may be included. The filtered result set may be provided to the user. The dating website may be a swinger's website. The plurality of mutually-exclusive descriptors may concern sexual orientation. The plurality of mutually-exclusive descriptors may concern user interest. The plurality of mutually-exclusive descriptors may concern user preference. The user profile may define a group of people or a single person.

In another implementation, a computer program product resides on a computer readable medium that has a plurality of instructions stored on it. When executed by a processor, the instructions cause the processor to perform operations including receiving a search request from a user of a dating website that defines one or more search criteria. The search criteria is compared to a plurality of user profiles to generate a result set of user profiles. At least one result set user profile included within the result set of user profiles includes a plurality of mutually-exclusive descriptors. The at least one result set user profile is filtered to remove one or more of the plurality of mutually-exclusive descriptors based, at least in part, upon the search criteria to generate a filtered result set of user profiles.

One or more of the following features may be included. The filtered result set may be provided to the user. The dating website may be a swinger's website. The plurality of mutually-exclusive descriptors may concern sexual orientation. The plurality of mutually-exclusive descriptors may concern user interest. The plurality of mutually-exclusive descriptors may concern user preference. The user profile may define a group of people or a single person.

In another implementation, a computing system includes at least one processor and at least one memory architecture coupled with the at least one processor, wherein the computing system is configured to perform operations including receiving a search request from a user of a dating website that defines one or more search criteria. The search criteria is compared to a plurality of user profiles to generate a result set of user profiles. At least one result set user profile included within the result set of user profiles includes a plurality of mutually-exclusive descriptors. The at least one result set user profile is filtered to remove one or more of the plurality of mutually-exclusive descriptors based, at least in part, upon the search criteria to generate a filtered result set of user profiles.

One or more of the following features may be included. The filtered result set may be provided to the user. The dating website may be a swinger's website. The plurality of mutually-exclusive descriptors may concern sexual orientation. The plurality of mutually-exclusive descriptors may concern user interest. The plurality of mutually-exclusive descriptors may concern user preference. The user profile may define a group of people or a single person.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a distributed computing network including a computing device that executes a data process according to an implementation of the present disclosure;

FIG. 2 is a flowchart of the data process of FIG. 1 according to an implementation of the present disclosure;

FIG. 3 is a diagrammatic view of a profile configuration screen rendered by the data process of FIG. 1 according to an implementation of the present disclosure;

FIGS. 4A-4B are diagrammatic views of profiles rendered by the data process of FIG. 1 according to an implementation of the present disclosure; and

FIGS. 5A-5B are diagrammatic views of profiles rendered by the data process of FIG. 1 according to an implementation of the present disclosure.

Like reference symbols in the various drawings indicate like elements.

### DETAILED DESCRIPTION OF THE PREFERRED EMBODIMENTS

### System Overview

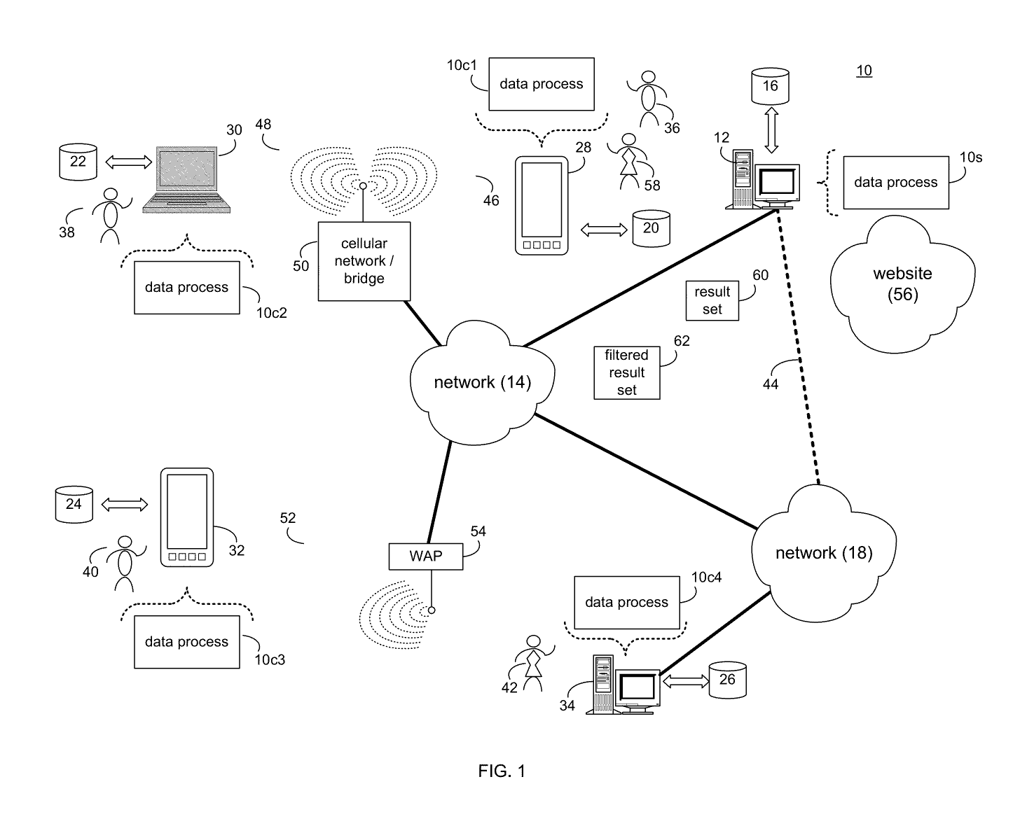

Referring to FIG. 1, there is shown data process 10. As will be discussed below in greater detail, data process 10 may be utilized to process data received from e.g., a first user and present that data (for example, in a modified/filtered form) to e.g., a second user.

Data process 10 may be implemented as a server-side process, a client-side process, or a hybrid server-side/client-side process. For example, data process 10 may be implemented as a purely server-side process via data process 10s. Alternatively, data process 10 may be implemented as a purely client-side process via one or more of client-side process 10c1, client-side process 10c2, client-side process 10c3, and client-side process 10c4. Alternatively still, data process 10 may be implemented as a hybrid server-side/client-side process via data process 10s in combination with one or more of client-side process 10c1, client-side process 10c2, client-side process 10c3, and client-side process 10c4. Accordingly, data process 10 as used in this disclosure may include any combination of data process 10s, client-side process 10c1, client-side process 10c2, client-side process 10c3, and client-side process 10c4.

Data process 10s may be a server application and may reside on and may be executed by computing device 12, which may be connected to network 14 (e.g., the Internet or a local area network). Examples of computing device 12 may include, but are not limited to: a personal computer, a laptop computer, a personal digital assistant, a data-enabled cellular telephone, a notebook computer, a television with one or more processors embedded therein or coupled thereto, a cable/satellite receiver with one or more processors embedded therein or coupled thereto, a server computer, a series of server computers, a mini computer, a mainframe computer, or a dedicated network device.

The instruction sets and subroutines of data process 10s, which may be stored on storage device 16 coupled to computing device 12, may be executed by one or more processors (not shown) and one or more memory architectures (not shown) included within computing device 12. Examples of storage device 16 may include but are not limited to: a hard disk drive; a tape drive; an optical drive; a RAID device; a random access memory (RAM); a read-only memory (ROM); and all forms of flash memory storage devices.

Network 14 may be connected to one or more secondary networks (e.g., network 18), examples of which may include but are not limited to: a local area network; a wide area network; or an intranet, for example.

Examples of client-side processes 10c1, 10c2, 10c3, 10c4 may include but are not limited to a web browser, a game console user interface, or a specialized application (e.g., an application running on e.g., the Android™ platform or the iPhone™ platform). The instruction sets and subroutines of client-side applications 10c1, 10c2, 10c3, 10c4, which may be stored on storage devices 20, 22, 24, 26 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Examples of storage devices 20, 22, 24, 26 may include but are not limited to: hard disk drives; tape drives; optical drives; RAID devices; random access memories (RAM); read-only memories (ROM), and all forms of flash memory storage devices.

Examples of client electronic devices 28, 30, 32, 34 may include, but are not limited to, data-enabled, cellular telephone 28, laptop computer 30, personal digital assistant 32, personal computer 34, a notebook computer (not shown), a server computer (not shown), a gaming console (not shown), a smart television (not shown), and a dedicated network device (not shown). Client electronic devices 28, 30, 32, 34 may each execute an operating system, examples of which may include but are not limited to Microsoft Windows™, Android™, WebOS™, iOS™, Redhat Linux™, or a custom operating system.

Users 36, 38, 40, 42 may access data process 10 directly through network 14 or through secondary network 18. Further, data process 10 may be connected to network 14 through secondary network 18, as illustrated with link line 44.

The various client electronic devices (e.g., client electronic devices 28, 30, 32, 34) may be directly or indirectly coupled to network 14 (or network 18). For example, data-enabled, cellular telephone 28 and laptop computer 30 are shown wirelessly coupled to network 14 via wireless communication channels 46, 48 (respectively) established between data-enabled, cellular telephone 28, laptop computer 30 (respectively) and cellular network/bridge 50, which is shown directly coupled to network 14. Further, personal digital assistant 32 is shown wirelessly coupled to network 14 via wireless communication channel 52 established between personal digital assistant 32 and wireless access point (i.e., WAP) 54, which is shown directly coupled to network 14. Additionally, personal computer 34 is shown directly coupled to network 18 via a hardwired network connection.

WAP 54 may be, for example, an IEEE 802.11a, 802.11b, 802.11g, 802.11n, Wi-Fi, and/or Bluetooth device that is capable of establishing wireless communication channel 52 between personal digital assistant 32 and WAP 54. As is known in the art, IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

### Data Process:

Assume for illustrative purposes that user 36 would like to join website 56. Examples of website 56 may include any form of network that members may join so that they may interact in some fashion. An example of website 56 may include a traditional social networking website in which members post updates concerning their personal life, exchange personal photos, and voice political opinions. Another example of website 56 may include a dating website in which members generate a profile for themselves and review profiles of other members to determine who they would like to contact. An additional example of website 56 may include an ecommerce website in which members define a profile (e.g., that identifies shipping addresses and payment methods) so that they may purchase merchandise online.

While the following example concerns website 56 being an alternative lifestyle website (specifically, a swingers website), this is for illustrative purposes only and is not intended to be a limitation of this disclosure, as other configurations are possible (such as the above-described ecommerce website and social networking web site).

As is known in the art, a swingers website is a website in which members (typically as couples) communicate and interact with each other so that they may engage in sexual encounters. For example, a husband and wife may become members of a swingers website, where each of these individuals defines a profile and these two profiles may be linked as a couple. Additionally, the swingers website (e.g., website 56) may be configured to allow individuals to join (thus not requiring individuals to join as couples).

Once the above-described profiles are established, the various members of the swingers website (e.g., website 56) may search the profiles of the other members of the swingers website to identify other couples/individuals with whom they would like to communicate and possibly engage in sexual encounters. For example, a male/female couple may wish to interact with another male/female couple. Alternatively, a male/female couple may wish to interact with a male individual . . . or may wish to interact with a female individual.

Data process 10 may be configured to allow e.g., user 36 to define the above-described user profile. Data process 10 may be a stand-alone process that is configured to interact with website 56. Alternatively, data process 10 may be a portion of/built into website 56.

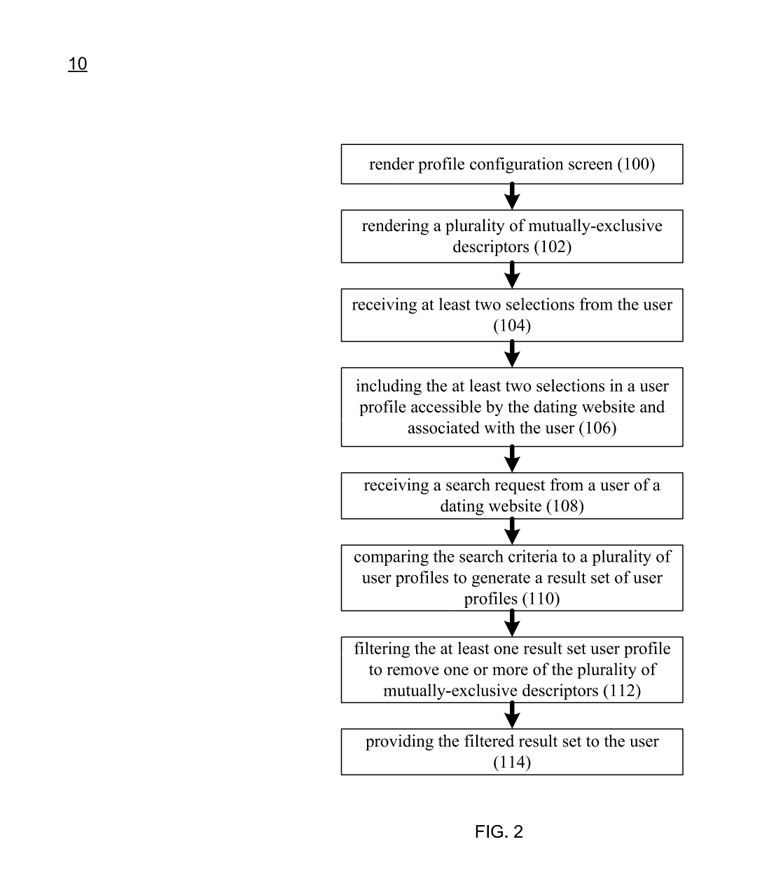

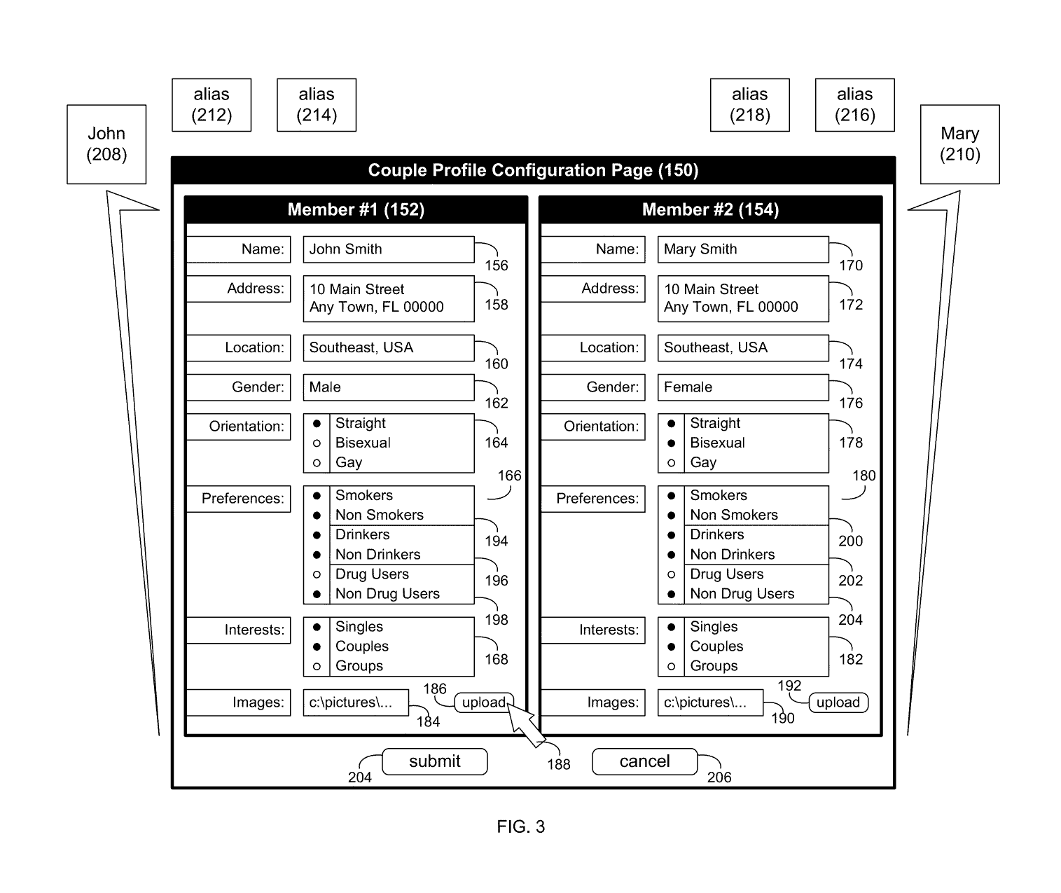

Referring also to FIGS. 2-3, data process 10 may be configured to render 100 profile configuration screen 150 that may be configured to allow (in this example) user 36 to define a user profile within profile definition window 152 for use with the swingers website (e.g., website 56). Assume for illustrative purposes that the wife of user 36 (e.g., user 58) would also like to establish a user profile within profile definition window 154 for use within the swingers website (e.g., website 56).

For example and when rendering 100 profile configuration screen 150, data process 10 may be configured to allow user 36 to define within profile definition window 152 a user name (within name field 156); a user address (within address field 158); a user location (within location field 160); a user gender (within gender field 162); a user sexual orientation (within orientation field 164); user preferences (within preferences field 166); and user interests (within interests field 168).

Further and when rendering 100 profile configuration screen 150, data process 10 may be configured to allow user 58 (e.g., the wife of user 36) to define within profile definition window 154 a user name (within name field 170); a user address (within address field 172); a user location (within location field 174); a user gender (within gender field 176); a user sexual orientation (within orientation field 178); user preferences (within preferences field 180); and user interests (within interests field 182).

Profile configuration screen 150 may also be configured (by data process 10) to allow user 36 and/or user 58 to upload one or more images for use within profile definition windows 152, 154 (respectively). For example, user 36 may locate an image file to be uploaded to website 58 within file location window 184 and, once located, may select “upload” button 186 using pointer 188 (controllable by e.g., a mouse; not shown). Further, user 58 may locate an image file to be uploaded to website 58 within file location window 190 and, once properly located, may select “upload” button 192 using pointer 188.

Data process 10 may render 102 a plurality of mutually-exclusive descriptors for use by users (e.g., users 36, 58) of the swingers website (e.g., website 56).

One example of data process 10 rendering 102 such mutually-exclusive descriptors for use by users (e.g., users 36, 58) of the swingers website (e.g., website 56) may include mutually-exclusive descriptors concerning sexual orientation.

For example and as discussed above, profile configuration screen 150 may allow user 36 to define their sexual orientation within orientation field 164 and may allow user 58 to define their sexual orientation within orientation field 178. Typically, these descriptors are considered mutually exclusive, in that most websites allow a person to only identify themselves as straight, bisexual, or gay. However and within website 56, data process 10 may be configured to provide the user (e.g., users 36 and/or user 58) with a higher level of flexibility concerning their desired types of sexual encounters, thus allowing (in this example) users 36, 58 to define themselves as: straight; bisexual; gay; straight & bisexual; straight & gay; bisexual & gay; and straight, bisexual & gay.

Specifically, assume that user 36 (who is male) is only interested in sexual encounters with women. Accordingly, user 36 may define themselves as “straight” within orientation field 164. However, if user 58 (who is female) is interested in sexual encounters with men and/or women, user 58 may define themselves as “straight” and “bisexual” within orientation field 178.

Another example of data process 10 rendering 102 such mutually-exclusive descriptors for use by users (e.g., users 36, 58) of the swingers website (e.g., website 56) may include mutually-exclusive descriptors concerning user preferences. For example: within preferences field 166, there are three subfields 194, 196, 198; and within preferences field 180, there are three subfields 200, 202, 204.

In this example, subfields 194, 200 concern smoking; subfields 196, 202 concern drinking; and subfield 198, 204 concern drug use. Within each of these subfields (and in this example) are two mutually-exclusive descriptors (e.g., smoker/non-smoker, drinker/non-drinker, user/non-user). Data process 10 may render 102 such mutually-exclusive descriptors so that the users (e.g., users 36, 58) of the swingers website (e.g., website 56) may select a set of mutually-exclusive descriptors. For example, data process 10 may be configured to render profile configuration screen 150 so that users (e.g., users 36, 58) may select e.g., smokers and non-smokers, drinkers and non-drinkers, and/or users and non-users.

A third example of data process 10 rendering 102 such mutually-exclusive descriptors for use by users (e.g., users 36, 58) of the swingers website (e.g., website 56) may include mutually-exclusive descriptors concerning user interests.

In this example, interest fields 168, 182 concern (in this example) the type of sexual encounters that users 36, 58 (respectively) may be interested in (via the mutually-exclusive descriptors singles, couples, groups). Data process 10 may render 102 such mutually-exclusive descriptors so that the users (e.g., users 36, 58) of the swingers website (e.g., website 56) may select two or more of the mutually-exclusive descriptors. For example, data process 10 may be configured to render profile configuration screen 150 so that users (e.g., users 36, 58) may select e.g., singles, couples, and/or groups.

Once user 36 and/or user 58 have finalized their selections (e.g., within profile definition window 152, 154 respectively), user 36 and/or user 58 may select “submit” button 204 using pointer 188 (controllable by e.g., a mouse; not shown). Alternatively, user 36 and/or user 58 may select “cancel” button 206 using pointer 188.

Once user 36 and/or user 58 selects “submit” button 204, data process 10 may receive 104 at least two selections from the user (users 36, 58), wherein these two selections are chosen from the plurality of mutually-exclusive descriptors described above. For example and with respect to user 36, data process 10 may receive 104 a first set of mutually-exclusive descriptors concerning the interest of user 36 in both smokers and non-smokers (as defined within subfield 194 of preferences field 166); may receive 104 a second set of mutually-exclusive descriptors concerning the interest of user 36 in both drinkers and non-drinkers (as defined within subfield 196 of preferences field 166); and may receive 104 a third set of mutually-exclusive descriptors concerning the interest of user 36 in both singles and couples (as defined within interests field 168).

Further and with respect to user 58, data process 10 may receive 104 a first set of mutually-exclusive descriptors concerning the interest of user 58 in both smokers and non-smokers (as defined within subfield 200 of preferences field 180); may receive 104 a second set of mutually-exclusive descriptors concerning the interest of user 36 in both drinkers and non-drinkers (as defined within subfield 202 of preferences field 180); may receive 104 a third set of mutually-exclusive descriptors concerning the interest of user 58 in both singles and couples (as defined within interests field 182); and may receive 104 a fourth set of mutually-exclusive descriptors concerning the sexual orientation of user 58 as both straight and bi-sexual (as defined within orientation field 178).

Upon receiving the above-described selections from the users, data process 10 may include 106 these selections made by the users into a user profile accessible by the swingers website (e.g., website 56) and associated with the users. For example, the mutually-exclusive descriptors defined within subfield 194 of preferences field 166, within subfield 196 of preferences field 166, and within interests field 168 may be included within user profile 208 created for user 36. Additionally, the mutually-exclusive descriptors defined within subfield 200 of preferences field 180, within subfield 202 of preferences field 180, within interests field 182, and within orientation field 178 may be included within user profile 210 created for user 58.

While the data process 10 is described above as defining two profiles (e.g., profiles 208, 210 for users 36, 58 (respectively) that are linked together as a couple), this is for illustrative purposes only, as other configurations are possible and are considered to be within the scope of this disclosure. For example, data process 10 may be configured to generate a “couple” user profile that describes the two individuals (e.g., user 36, 58) that are included in the couple.

Additionally, data process 10 may be configured to allow the users (e.g., users 36, 58) of the swingers website (e.g., website 56) to define one or more aliases that may be associated with (in this example) user profiles 208, 210.

Accordingly and in furtherance of the above-stated example, data process 10 may be configured to allow user 36 to define a first alias (e.g., alias 212) that basically mimics profile 208 but defines the sexual orientation of user 36 as (exclusively) bisexual. Further, data process 10 may be configured to allow user 36 to define a second alias (e.g., alias 214) that basically mimics profile 208 but defines the location and address of user 36 as Seattle, Wash. (where user 36 went to college).

Additionally, data process 10 may be configured to allow user 58 to define a first alias (e.g., alias 216) that basically mimics profile 210 but defines the sexual orientation of user 58 as (exclusively) straight. Further, data process 10 may be configured to allow user 58 to define a second alias (e.g., alias 218) that basically mimics profile 210 but defines the location and address of user 58 as Chicago, Ill. (where user 58 frequently travels to on business).

By allowing (in this example) users 36, 58 to define one of more aliases, a higher level of convenience is provided to users 36, 58, as these users are provided with a higher level of flexibility concerning the manner in which they describe themselves (without requiring the user to set up multiple user accounts). Further, by associating the aliases with the primary profile (e.g., profile 208 for user 36 and profile 210 for user 58), data process 10 may be configured to allow the user to monitor and manage their user profile and all of their aliases by simply logging into one account.

For example, when user 36 logs into the user account associated with user profile 208, data process 10 may be configured so that all communications from third parties concerning aliases 212, 214 are routed to the user account associated with user profile 208. Accordingly, user 36 may monitor user profile 208, alias 212 and alias 214 by simply monitoring user profile 208. Further, when user 58 logs into the user account associated with user profile 210, data process 10 may be configured so that all communications from third parties concerning aliases 216, 218 are routed to the user account associated with user profile 210. Accordingly, user 58 may monitor user profile 210, alias 216 and alias 218 by simply monitoring user profile 210.

Data process 10 may be configured to receive search requests concerning the swingers website (e.g., website 56) and to generate result sets based upon the search criteria included in the search requests received. Additionally, if the user profiles included within the result set include any of the above-described, mutually-exclusive descriptors, these mutually-exclusive descriptors may be filtered prior to providing the result set to the search requestor.

Continuing with the above-stated example, assume that user 38 is a non-smoking, non-drinking, female who is interested in a sexual encounter with a couple including a straight male and a bisexual female. Accordingly, user 38 may enter a search request in a search screen (not shown) effectuated by data process 10 and included within the swingers website (e.g., website 56). For the following example, assume that user 38 defines a search request seeking a couple (including a straight male and a bisexual female) that prefers non-smokers/non-drinkers/non drug users and seeks encounters with singles that are located within the State of Florida.

Data process 10 may receive 108 a search request from a user of a dating website that defines one or more search criteria. As discussed above and for this example, assume that data process 10 receives 108 the above-described search request from user 38 of the swingers website (e.g., website 56), wherein the search request includes search criteria seeking a couple (including a straight male and a bisexual female) that prefers non-smokers/non-drinkers/non drug users and seeks encounters with singles that are located within the State of Florida.

Data process 10 may compare 110 the above-described search criteria (e.g., a couple that includes a straight male and a bisexual female that prefers non-smokers/non-drinkers/non drug users and seeks encounters with singles that are located within the State of Florida) to a plurality of user profiles (e.g., the user profiles included within the swingers website (e.g., website 56) including, but not limited to, user profiles 208. 210) to generate a result set (e.g., result set 60) of user profiles. Assume for illustrative purposes that user profiles 208. 210 are included within result set 60.

If one or more of the user profiles included within result set 60 includes a plurality of mutually-exclusive descriptors (as described above), data process 10 may filter 112 the user profiles included within result set 60 to remove the plurality of mutually-exclusive descriptors based, at least in part, upon the search criteria to generate filtered result set 62 of user profiles. As discussed above, the search criteria entered by user 38 sought a couple (including a straight male and a bisexual female) that prefers non-smokers/non-drinkers/non drug users and seeks encounters with singles that are located within the State of Florida. Data process 10 may provide 114 filtered result set 62 to the user requesting the search (e.g., user 38) so that e.g., user 38 may review the user profiles (e.g., user profiles 208, 210) included within filtered result set 62 to determine whether they would like to initiate contact with any of the people identified within filtered result set 62.

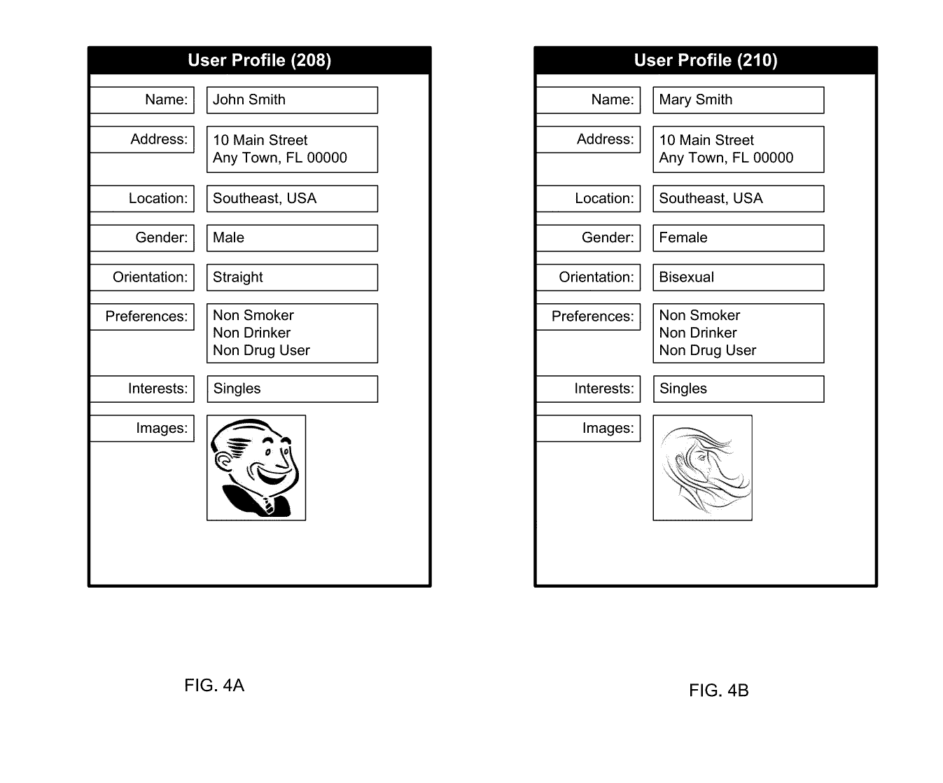

Referring also to FIGS. 4A-4B, data process 10 may provide 114 filtered result set 62 to user 38 that includes user profiles 208, 210 (for users 36, 58, respectively).

Since user 38 was interested in non-smokers and non-drinkers, data process 10 may filter 112 user profile 208 to remove the mutually-exclusive descriptor that defines the preference of user 36 to include “smokers” and “drinkers”. Further, data process 10 may filter 112 user profile 208 to remove the mutually-exclusive descriptor that defines the interest of user 36 in “couples” (as user 38 is a single individual).

Since user 38 was looking for a bisexual female, data process 10 may filter 112 user profile 210 to remove the mutually-exclusive descriptor that defines the sexual orientation of user 58 as “straight”. Additionally, data process 10 may filter 112 user profile 210 to remove the mutually-exclusive descriptor that defines the preference of user 58 to include “smokers” and “drinkers” (as user 38 was interested “non-smokers” and non-drinkers”). Further, data process 10 may filter 112 user profile 210 to remove the mutually-exclusive descriptor that defines the interest of user 58 in “couples” (as user 38 is a single individual).

As discussed above, if one or more of the user profiles included within result set 60 includes a plurality of mutually-exclusive descriptors (as described above), data process 10 may filter 112 the user profiles included within result set 60 to remove the plurality of mutually-exclusive descriptors based, at least in part, upon the search criteria to generate filtered result set 62 of user profiles. Accordingly, as the search criteria changes, the manner in which data process 10 filters 112 result set 60 may also change.

Assume for another example that users 40, 42 are a husband and wife couple and are members of the swingers website (e.g., website 56). Further, assume that user 40 is a smoking, drinking, male who is interested in a sexual encounter with a couple including a straight male and a straight female. Further, assume that user 42 is a smoking, drinking, female who is interested in a sexual encounter with a couple including a straight male and a straight female.

Accordingly, users 40, 42 may enter a search request in a search screen (not shown) effectuated by data process 10 and included within of the swingers website (e.g., website 56). For the following example, assume that users 40, 42 define a search request seeking a couple (including a straight male and a straight female) that prefers smokers/drinkers/non drug users and seeks encounters with another couple that is located within the State of Florida.

Data process 10 may receive 108 the above-described search request from users 40, 42 and may compare 110 the above-described search criteria (e.g., a couple that includes a straight male and a straight female that prefers smokers/drinkers/non drug users and seeks encounters with another couple that is located within the State of Florida) to a plurality of user profiles (e.g., the user profiles included within the swingers website (e.g., website 56) including, but not limited to user profiles 208. 210) to generate a result set (e.g., result set 60) of user profiles. Again, assume for illustrative purposes that user profiles 208. 210 are included within result set 60.

As discussed above, the search criteria entered by users 40, 42 sought a couple (including a straight male and a straight female) that prefers smokers/drinkers/non drug users and seeks encounters with another couple that is located within the State of Florida. Data process 10 may provide 114 filtered result set 62 to the user(s) requesting the search (e.g., users 40, 42) so that e.g., users 40, 42 may review the user profiles (e.g., user profiles 208, 210) included within filtered result set 62 to determine whether they would like to initiate contact with any of the people identified within filtered result set 62.

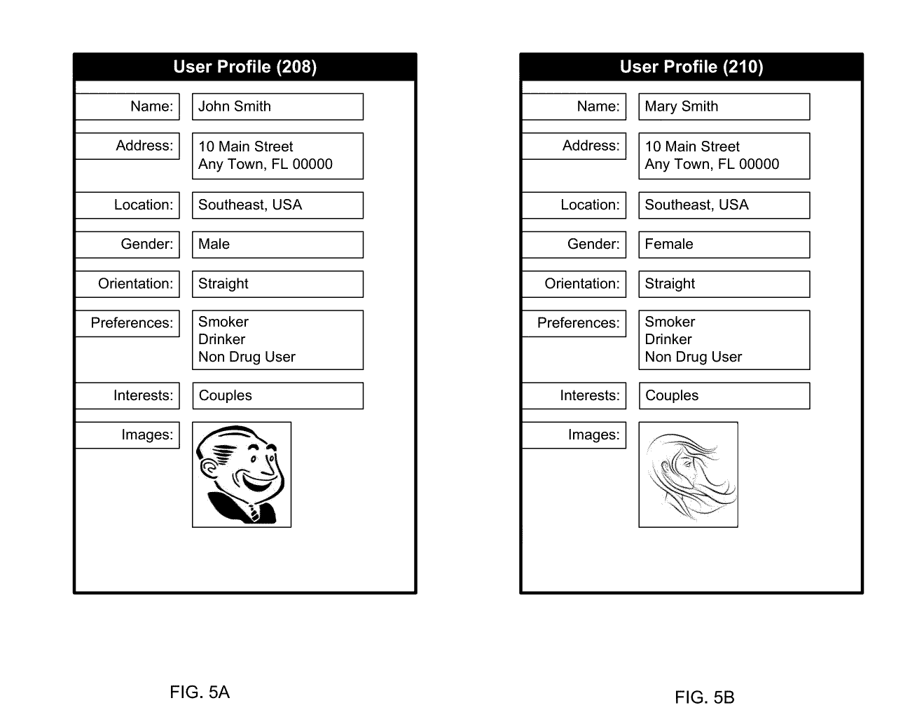

Referring also to FIGS. 5A-5B, since users 40, 42 were interested in smokers and drinkers, data process 10 may filter 112 user profile 208 to remove the mutually-exclusive descriptor that defines the preference of user 36 to include “non smokers” and “non drinkers”. Further, data process 10 may filter 112 user profile 208 to remove the mutually-exclusive descriptor that defines the interest of user 36 in “singles” (as users 40, 42 are a couple).

Since users 40, 42 were looking for a straight female, data process 10 may filter 112 user profile 210 to remove the mutually-exclusive descriptor that defines the sexual orientation of user 58 as “bisexual”. Additionally, data process 10 may filter 112 user profile 210 to remove the mutually-exclusive descriptor that defines the preference of user 58 to include “non smokers” and “non drinkers” (as users 40, 42 were interested “smokers” and drinkers”). Further, data process 10 may filter 112 user profile 210 to remove the mutually-exclusive descriptor that defines the interest of user 58 in “singles” (as users 40, 42 are a couple).

### General:

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer-implemented method, executed on a computing system, comprising:
receiving a search request from a user of a dating website that defines one or more search criteria;
comparing the search criteria to a plurality of user profiles to generate a result set of user profiles, wherein at least one result set user profile included within the result set of user profiles includes a plurality of mutually-exclusive descriptors; and
filtering the at least one result set user profile to remove one or more of the plurality of mutually-exclusive descriptors based, at least in part, upon the search criteria to generate a filtered result set of user profiles.

2. The computer-implemented method of claim 1 further comprising:
providing the filtered result set to the user.

3. The computer-implemented method of claim 1 wherein the dating website is a swinger's website.

4. The computer-implemented method of claim 1 wherein the plurality of mutually-exclusive descriptors concern sexual orientation.

5. The computer-implemented method of claim 1 wherein the plurality of mutually-exclusive descriptors concern user interest.

6. The computer-implemented method of claim 1 wherein the plurality of mutually-exclusive descriptors concern user preference.

7. The computer-implemented method of claim 1 wherein the user profile defines: a group of people or a single person.

8. A computer program product residing on a computer readable medium having a plurality of instructions stored thereon which, when executed by a processor, cause the processor to perform operations comprising:
receiving a search request from a user of a dating website that defines one or more search criteria;
comparing the search criteria to a plurality of user profiles to generate a result set of user profiles, wherein at least one result set user profile included within the result set of user profiles includes a plurality of mutually-exclusive descriptors; and
filtering the at least one result set user profile to remove one or more of the plurality of mutually-exclusive descriptors based, at least in part, upon the search criteria to generate a filtered result set of user profiles.

9. The computer program product of claim 8 further comprising instructions for:
providing the filtered result set to the user.

10. The computer program product of claim 8 wherein the dating website is a swinger's website.

11. The computer program product of claim 8 wherein the plurality of mutually-exclusive descriptors concern sexual orientation.

12. The computer program product of claim 8 wherein the plurality of mutually-exclusive descriptors concern user interest.

13. The computer program product of claim 8 wherein the plurality of mutually-exclusive descriptors concern user preference.

14. The computer program product of claim 8 wherein the user profile defines: a group of people or a single person.

15. A computing system including a processor and memory configured to perform operations comprising:
receiving a search request from a user of a dating website that defines one or more search criteria;
comparing the search criteria to a plurality of user profiles to generate a result set of user profiles, wherein at least one result set user profile included within the result set of user profiles includes a plurality of mutually-exclusive descriptors; and
filtering the at least one result set user profile to remove one or more of the plurality of mutually-exclusive descriptors based, at least in part, upon the search criteria to generate a filtered result set of user profiles.

16. The computing system of claim 15 further configured to perform operations comprising:
providing the filtered result set to the user.

17. The computing system of claim 15 wherein the dating website is a swinger's website.

18. The computing system of claim 15 wherein the plurality of mutually-exclusive descriptors concern sexual orientation.

19. The computing system of claim 15 wherein the plurality of mutually-exclusive descriptors concern user interest.

20. The computing system of claim 15 wherein the plurality of mutually-exclusive descriptors concern user preference.

21. The computing system of claim 15 wherein the user profile defines: a group of people or a single person.
